(19) United States
(12) Patent Application Publication
(10) Pub. No.: US 2025/0248392 A1
(43) Pub. Date: Aug. 7, 2025

(54) LETHAL BAIT FOR PEST ANT CONTROL

(71) Applicant: Gerhard Gries, Coquitlam (CA)

(72) Inventors: Asim Renyard, New Westminster (CA); Gerhard Gries, Coquitlam (CA)

(21) Appl. No.: 19/042,407

(22) Filed: Jan. 31, 2025

Related U.S. Application Data
(60) Provisional application No. 63/549,113, filed on Feb. 2, 2024.

(51) Int. Cl. A01N 25/00; A01N 25/02; A01N 59/14; A01P 7/04; A01P 19/00

(52) U.S. Cl. CPC A01N 25/006; A01N 25/02; A01N 59/14; A01P 7/04; A01P 19/00

(57) ABSTRACT

Compositions for controlling ants include one or more essential amino acids (EAAs); one or more sugar compounds; and a lethal agent. Such compositions can be liquid bait compositions. A method of using such compositions can include deploying compositions in an ant bait station and positioning the ant bait station near an ant nest.

### REFERENCE TO RELATED APPLICATIONS

The present application claims the priority of U.S. provisional application Ser. No. 63/549,113, entitled LETHAL BAIT FOR PEST ANT CONTROL, filed Feb. 2, 2024, and hereby incorporates the same application herein by reference in its entirety.

### TECHNICAL FIELD

The present disclosure generally relates to a lethal ant bait. Specifically, the present disclosure relates to a liquid bait composition including essential amino acids (EAAs) and a sugar compound, as well as to methods of using the same.

### BACKGROUND

The presence of pest ants can be damaging in a variety of ways, and controlling ants is difficult. Certain control tactics have not been successful at reducing ant populations (e.g., through biocontrol agents), whereas large-scale insecticide sprays may not be desirable due to adverse effects on non-target species and an inability to reach the entire ant population. In theory, lethal ant baits represent a solid option for controlling ants, as the food-sharing behavior of ants helps distribute lethal agents to workers, queens and brood, while reducing adverse effects on non-target species. What is desired is a lethal ant bait that appeals to ants, causes delayed toxicity and includes a suitable bait matrix.

### SUMMARY

According to one embodiment, a composition for eliminating ants includes one or more essential amino acids (EAAs), wherein the one or more EAAs are included in an amount of up to 5%, weight by volume (w/v)); one or more sugar compounds; and a lethal agent.

According to another embodiment, a liquid bait composition for controlling ants includes from about 1% to about 5% (w/v) of one or more EAAs, wherein the one or more EAAs include one or more of L-glutamic acid, L-alanine, L-isoleucine, L-leucine, L-valine, L-tryptophan, L-arginine, L-histidine, L-threonine, L-methionine, and L-phenylalanine; from about 1% to about 50% (w/v) of one or more sugar compounds; from about 1% to about 5.4% (w/v) of a lethal agent; and water.

### BRIEF DESCRIPTION OF THE DRAWINGS

FIG. 1a depicts a perspective view of an experimental design used to test consumption of liquid nutrient baits by ants;

FIG. 1b depicts a perspective view of another experimental design used to test consumption of liquid nutrient baits by ants;

FIG. 2 depicts (a) a chart showing the proportional consumption of aqueous amino acid baits by colonies of Camponotus modoc carpenter ants; (b) another chart showing the proportional consumption of aqueous amino acid baits by colonies of Camponotus modoc carpenter ants; (c) a chart showing the proportional consumption of aqueous amino acid baits by colonies of Myrmica rubra fire ants; and (d) another chart showing the proportional consumption of aqueous amino acid baits by colonies of Myrmica rubra fire ants;

FIG. 3 depicts (a) a chart showing the comparative consumption of liquid food baits by colonies of Camponotus modoc carpenter ants; (b) another chart showing the comparative consumption of liquid food baits by colonies of Camponotus modoc carpenter ants, at adjusted nutrient concentrations; (c) a chart showing the comparative consumption of liquid food baits by colonies of Myrmica rubra fire ants; and (d) another chart showing the comparative consumption of liquid food baits by colonies of Myrmica rubra fire ants, at adjusted nutrient concentrations;

FIG. 4 depicts (a) a chart showing the comparative consumption of liquid food baits by colonies of Camponotus modoc carpenter ants; (b) another chart showing the comparative consumption of liquid food baits by colonies of Camponotus modoc carpenter ants, at adjusted nutrient concentrations; (c) a chart showing the comparative consumption of liquid food baits by colonies of Myrmica rubra fire ants; and (d) another chart showing the comparative consumption of liquid food baits by colonies of Myrmica rubra fire ants, at adjusted nutrient concentrations;

FIG. 5 depicts (a) a chart showing consumption of liquid food baits by field colonies of Camponotus modoc carpenter ants; and (b) a chart showing consumption of liquid food baits by field colonies of Mymica rubra fire ants;

FIG. 6a depicts a side view of a tube used to test consumption of liquid nutrient baits by field colonies of ants;

FIG. 6b depicts the tube of FIG. 6a in an experimental design used to test consumption of liquid nutrient baits by field colonies of ants;

FIG. 7 depicts (a) a chart showing consumption of liquid food baits by field colonies of Lasius niger black garden ants; and (b) a chart showing consumption of liquid food baits by field colonies of Formica aserva thatching ants;

FIG. 8 depicts (a) a chart showing the effect of lethal and non-lethal liquid food baits on the survival of worker Myrmica rubra fire ants; (b) a chart showing the effect of lethal and non-lethal liquid food baits on the survival of queen Myrmica rubra fire ants; (c) a chart showing the effect of lethal and non-lethal liquid food baits on the survival of workers of Formica oreas thatching ants; and (d) a chart showing the effect of lethal and non-lethal liquid food baits on the survival of workers of Camponotus modoc carpenter ants;

FIG. 9 depicts (a) a chart showing the effect of lethal boric acid concentration in liquid baits on the survival of worker Myrmica rubra fire ants; and (b) a chart showing the effect of lethal boric acid concentration in liquid baits on the survival of queen Myrmica rubra fire ants;

FIG. 10 depicts a chart showing the proportional consumption of non-lethal liquid baits and concurrently offered non-lethal gel baits of identical nutrient composition by laboratory colonies of Myrmica rubra fire ants;

FIG. 11 depicts a chart showing the proportional demise of Myrmica rubra fire ant colonies, including workers and queens, feeding on either the lethal liquid bait or the lethal gel bait with identical nutrient composition and lethal agent concentration; and

FIG. 12 depicts a chart showing the demographics of Myrmica rubra fire ant colonies feeding on lethal baits or non-lethal baits.

### DETAILED DESCRIPTION

The present disclosure generally relates to compositions for controlling one or more ant species, including populations of ants, particularly pest ants that have invaded geographic areas where they were not previously present. Generally, the compositions can include one or more EAAs; a sugar compound; and a lethal agent. In certain embodiments, the compositions can be used to control, for example, Camponotus modoc carpenter ants, Myrmica rubra fire ants, Formica oreas thatching ants, and Lasius niger black garden ants.

As will be appreciated, the compositions can be lethal ant baits that are sufficiently appealing to ants, cause delayed toxicity, and include a suitable bait matrix. For example, the compositions can exhibit sufficient appeal to draw the attention of foraging ants and remain appealing throughout a foraging season. The compositions exhibit delayed toxicity to allow for the bait to be carried to the ants' nest and be distributed therein. The compositions can be presented in a bait matrix that can effectively be taken up, carried, and/or ingested by ants.

In certain embodiments, the composition can include one or more EAAs. For example, one or more of L-glutamic acid, L-alanine, L-isoleucine, L-leucine, L-valine, L-tryptophan, L-arginine, L-histidine, L-threonine, L-methionine, and L-phenylalanine. It will be appreciated that, in certain embodiments, the composition can include each of L-glutamic acid, L-alanine, L-isoleucine, L-leucine, L-valine, L-tryptophan, L-arginine, L-histidine, L-threonine, L-methionine, and L-phenylalanine.

The composition can include, in certain embodiments, about 1% to about 5% (w/v) of the one or more EAAs; in certain embodiments, about 1% to about 4%, by weight, of the one or more EAAs; in certain embodiments, about 1% to about 3% (w/v) of the one or more EAAs; and in certain embodiments, about 1% to about 2% (w/v) of the one or more EAAs. As can be appreciated, amounts of EAAs totaling more than 5% (w/v) may have a deterrent effect on ants.

In embodiments with two or more EAAs, each of the one or more EAAs can be provided in the same amount. For example, in certain embodiments, the composition can include about 0.091% (w/v) of each of L-glutamic acid, L-alanine, L-isoleucine, L-leucine, L-valine, L-tryptophan, L-arginine, L-histidine, L-threonine, L-methionine, and L-phenylalanine. In other embodiments, each of the one or more EAAs can be provided in any equal amount for which the total amounts to about 1% to about 5% (w/v) of the composition. It will be appreciated, however, that each EAA can be provided in any suitable amount provided that a total amount of EAAs is provided within the ranges described herein.

In certain embodiments, the compositions can include a sugar compound. For example, suitable examples of sugar compounds can include relatively simple sugars such as glucose, fructose, and galactose, and any more complex sugars such as sucrose, lactose, and maltose. However, it will be appreciated that any of a variety of suitable sugar compounds can be employed. It will also be appreciated that a combination of sugar compounds may be used in certain embodiments.

The composition can include, in certain embodiments, about 1% to about 50% (w/v) of the one or more sugar compounds; in certain embodiments, about 1.5% to about 40% (w/v) of the one or more sugar compounds; in certain embodiments, about 2% to about 30% (w/v) of the one or more sugar compounds; in certain embodiments, about 2.5% to about 20% (w/v) of the one or more sugar compounds; in certain embodiments, about 3% to about 15% (w/v) of the one or more sugar compounds; in certain embodiments, about 3.5% to about 10% (w/v) of the one or more sugar compounds; in certain embodiments, about 4% to about 8% (w/v) of the one or more sugar compounds; and in certain embodiments, about 4% to about 6% (w/v) of the one or more sugar compounds.

In certain embodiments, the sugar compound can be sucrose. As will be appreciated, sucrose can be a sugar compound that is preferred by ants. In certain embodiments where the sugar compound is sucrose, the composition can include, in certain embodiments, about 1% to about 50% (w/v) of sucrose; in certain embodiments, about 4% to about 50% (w/v) of sucrose; in certain embodiments, about 4% to about 40% (w/v) of sucrose; in certain embodiments, about 4% to about 25% (w/v) of sucrose; in certain embodiments, about 4% to about 10% (w/v) of sucrose. In certain embodiments, the composition can include about 4% to about 5% (w/v) of sucrose; in certain embodiments, about 4.2% to about 4.8% (w/v) of sucrose; in certain embodiments, about 4.3% to about 4.7% (w/v) of sucrose; in certain embodiments, about 4.4% to about 4.6% (w/v) of sucrose; and in certain embodiments, about 4.5% to about 4.6% (w/v) of sucrose. For example, the composition can include, according to one example, about 4.55% (w/v) of the sugar compound, where the sugar compound is sucrose.

In certain embodiments, the compositions can include a lethal agent. In certain embodiments, boric acid can be suitable example of a lethal agent. As will be appreciated, boric acid can be a preferred lethal agent for several reasons. As described in the examples, the presence of boric acid in a composition does not cause aversion by the ants. In an aqueous solution, boric acid exhibits antimicrobial properties, which prevents spoilage of the bait's nutrients. Boric acid exhibits a relatively low toxicity to non-target organisms, but causes high mortality of ant populations. Generally, prolonged consumption by ants of baits with boric acid as the lethal agent can provide the best results for ant mortality. It will be appreciated, however, that any of a variety of suitable lethal agents can be employed.

The composition can include, in certain embodiments, about 1% to about 5.4% (w/v) of the lethal agent; in certain embodiments, about 1% to about 5% (w/v) of the lethal agent; about 1% to about 4% (w/v) of the lethal agent; in certain embodiments, about 1% to about 3% (w/v) of the lethal agent; and in certain embodiments, about 1% to about 2% (w/v) of the lethal agent. In certain embodiments, the composition can include about 1% (w/v) of the lethal agent.

In addition to one or more sugar compounds and EAAs, in certain embodiments, the composition can further include one or more non-essential amino acids (non-EAAs). For example, suitable non-EAAs can include one or more of L-asparagine, L-aspartic acid, L-cyteine, L-glutamine, L-glycine, L-lysine, L-proline, L-serine, L-tyrosine, and T-amino butyric acid. It will be appreciated that, in certain embodiments, the composition can include each of L-asparagine, L-aspartic acid, L-cysteine, L-glutamine, L-glycine, L-lysine, L-proline, L-serine, L-tyrosine, and T-amino butyric acid. In embodiments with two or more non-EAAs, each of the one or more non-EAAs can be provided in the same amount. For example, in certain embodiments, the composition can include about 0.1% (w/v) of each of L-asparagine, L-aspartic acid, L-cyteine, L-glutamine, L-glycine, L-lysine, L-proline, L-serine, L-tyrosine, and T-amino butyric acid. It will be appreciated, however, that an individual non-EAA can be provided in any suitable amount.

It will be appreciated that the composition may include any of a variety of suitable additional components. For example, in certain embodiments, the composition may further include urea, biurets, amides, carbamates, carbodiimides, and thiocarbamides.

The composition may be provided in any of a variety of suitable bait matrices, such as a liquid bait composition or a gel bait composition. As will be appreciated, the liquid bait composition may be better suited for ants that preferentially forage for, and take up, liquid food such as floral nectar or aphid honeydew. Ants collect both solid foods (e.g., prey for larval offspring) and liquid food (e.g., floral nectar, aphid honeydew), but may prefer liquid foods due to the narrow constriction at their petiole. The liquid bait composition can be an aqueous composition. In such embodiments, the liquid bait composition can include the components as described herein, in the ranges of amounts described herein, in combination with water. Water can comprise, in certain embodiments, the balance of the liquid bait composition.

In one embodiment, for example, a liquid bait composition for controlling ants can include from about 1% to about 5% (w/v) of one or more EAAs, wherein the one or more EAAs include one or more of L-glutamic acid, L-alanine, L-isoleucine, L-leucine, L-valine, L-tryptophan, L-arginine, L-histidine, L-threonine, L-methionine, and L-phenylalanine; from about 1% to about 50% (w/v) of one or more sugar compounds; from about 1% to about 5.4% (w/v) of a lethal agent; and water.

As described herein, the composition can be used to target, for example, Camponotus modoc carpenter ants, Myrmica rubra fire ants, Formica oreas thatching ants, and Lasius niger black garden ants. The composition can be used to target ant species in the following subfamilies: Agroecomyrmecinae; Amblyoponinae; Dolichoderinae; Dorylinae; Ectatomminae; Formicinae; Heteroponerinae; Leptanillinae; Martialinae; Myrmeciinae; Myrmicinae; Paraponerinae; Ponerinae; Proceratiinae; and Pseudomyrmecinae. In certain embodiments, the compositions can be appealing to sugar-loving ants, protein-loving ants, or both groups of ants. Providing an attractive composition for both sugar-loving ants and protein-loving ants can help ensure that the composition remains appealing to ants throughout the foraging season. It will be appreciated, however, that compositions for controlling ants can be used to target any of a variety of ant species.

Methods for using liquid bait compositions can include deploying the liquid bait composition in a device (e.g., bait station) and positioning the device near an ant nest. In certain embodiments, the device can be one or more bait stations that include the liquid bait composition. In such embodiments, the bait station can be a tube (e.g., Eppendorf tube, Falcon tube). Use of bait stations to deliver liquid bait compositions can introduce less insecticide to an environment than insecticide sprays. It will be appreciated that methods may vary based on the ant species and the area inhabited by ants, among other factors.

### EXAMPLES

In preparation for testing, several species of ants were collected. Colonies of western carpenter ants, Camponotus modoc, each containing workers, brood, and a queen, were collected near Squamish, British Columbia, Canada. Colonies were harvested by cutting out infested log sections with a chainsaw (Husqvarna 394, 61 cm bar), placing them in large plastic bins (64 cm×79 cm×117 cm), and transporting them to the Science Research Annex (490 16′33″ N, 1220 54′55″ W) of Simon Fraser University (SFU). In an outdoor undercover area of this Annex, the colonies were exposed to natural light and temperature cycles throughout the year.

Each bin housing an ant colony was connected via clear Nalgene™ 180 (PVC) tubing (2.54 cm I.D.; Sigma-Aldrich, St. Louis, MO, USA) to a glass aquarium (51 cm×28 cm×30 cm), which served as the foraging area for ants. Bins were connected to glass containers via barbed plumbing fixtures and Nalgene™ tubing. Ants were provisioned with 20% (w/v) sugar water, honey, canned chicken, cockroaches, meal worms, and apples ad libitum.

Colonies of European fire ants, Myrmica rubra, each containing workers, brood, and one or more queens, were excavated at Inter River Park (North Vancouver, BC, Canada) and placed, together with nesting soil, in glass containers (26 cm×21 cm×40.6 cm) or plastic bins (41 cm×29 cm×24 cm) with mesh-covered holes in container or bin lids for air exchange. To retain ants, upper inner container or bin walls were coated with Vaseline and paraffin oil. Containers and bins were kept indoors at 25° C. and at a 16:8 light dark cycle. Colonies were sprayed with water several times per week, and ants were provisioned with 20% (w/v) sugar water, cockroaches, meal worms, and apples ad libitum.

To collect Formica oreas thatching ant colonies, thatch mounds and soil were dug up along roadside ditches near Port Kells (Surrey, BC, Canada) and placed into large plastic bins (67.3 cm×42.9 cm×34.5 cm) for transport to the Science Research Annex. There, these large bins were connected to smaller plastic bins (37.6 cm×24.4 cm×23.6 cm) via polyvinylchloride (Nalgene™) tubing and barbed plastic plumbing fixtures, thus allowing ants to move between bins. The smaller bins served as the ants' foraging area and were provisioned with food and sugar water (see above). Air exchange and retention of ants were achieved as described for M. rubra.

Liquid nutrient solutions for experiments (see Table 1 for nutrient concentrations) were prepared by weighing dry ingredients (TR 204 scale; Denver Instrument Company, CO, USA), and then mixing them in distilled water. Aliquots (1 mL) of these solutions were pipetted into 1.5-mL Eppendorf tubes (Thermo Fisher Scientific, Waltham, MA 02451, U.S.A.) which were stored in a freezer (−4° C.) until needed.

Prior to experiments, Eppendorf tubes were removed from the freezer to thaw, and then vortexed to dissolve all solutes. Then, a 1-cm long piece of cotton dental wick (Richmond Dental & Medical, Charlotte, NC 28205, USA) was inserted into each tube, thus allowing ants to ingest the liquid without spillage. Also prior to bioassays, colonies were deprived of sugar water and food for 24 hours and 4 hours, respectively (the maximum time ants could endure without these foods before they attempted to chew their way out of containers).

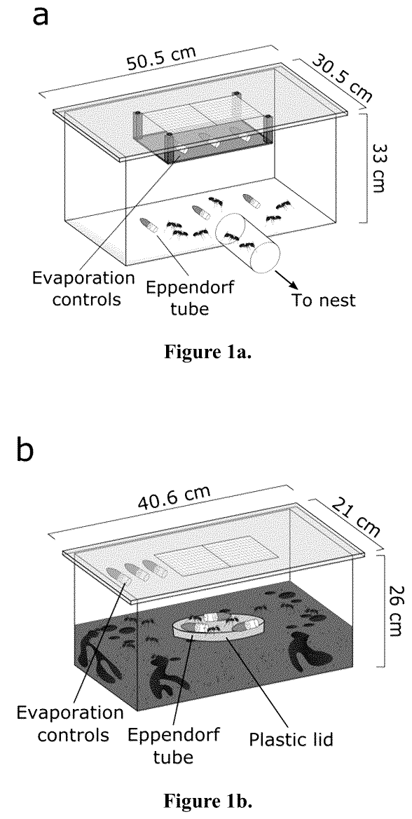

Experiments with C. modoc colonies (n=6) were run in plexiglass containers (50.5 cm×30.5 cm×33 cm; FIG. 1a) covered by a lid with mesh holes to allow ventilation. To prevent ant escape, the upper inner container walls were coated with an equal mix of Vaseline (Unilever, London, UK) and paraffin oil (Anachemia, Lachine, QC H8R1A3, Canada). For each experiment, we prepared a set of Eppendorf tubes for nutrient consumption by ants and another set of tubes for monitoring passive water evaporation (“evaporation control tubes”).

All Eppendorf tubes were weighed prior to bioassays. Eppendorf tubes were taped, with positions randomly assigned and spaced equidistantly in an arc, to the arena bottom, 22 cm away from the container entrance hole. Corresponding evaporation control tubes were taped to a plexiglass platform suspended from the container lid. To initiate a replicate, tubes were uncapped and each container was connected via Tygon® tubing (diam.: 2.54 cm) and barbed plumbing connectors (diam.: 2.54 cm) to a C. modoc housing bin, allowing ants to freely forage in the container.

Experimental replicates were run for 4 hours but were terminated sooner if ants had completely consumed the test solution of any one tube. At the end of each replicate, tubes were reweighed to determine consumption by ants and the amount of water evaporation. Experiment containers were cleaned with hexane and ethanol (70%), and plumbing fixtures and Tygon® tubing were washed with soapy water.

All experiments with M. rubra colonies (n=6) were run in their nesting containers (FIG. 1b). Prior to each experimental replicate, all Eppendorf tubes were weighed, and tubes with nutrients for consumption by ants were randomly assigned to positions on the edge of a jar lid (diam: 15 cm), whereas corresponding evaporation control tubes were taped, inaccessible to ants, to the underside of container lids. Experimental replicates were initiated by uncapping all Eppendorf tubes, and placing the jar lids with Eppendorf tubes on the soil surface inside experiment containers. Experiments were run for 6 hours but were terminated sooner if ants had consumed the entire nutrient solution in an Eppendorf tube. Tubes were capped and reweighed after replicates to determine nutrient consumption by ants. Jar lids were cleaned with soapy water between experiments.

All experiments with colonies of C. modoc and M. rubra were run on warm, sunny days with observable ant activity. Experiment durations for C. modoc and M. rubra colonies were based on both ant colony size and preliminary experiments that determined the time needed to obtain measurable consumption responses.

Data of all laboratory and field experiments were analyzed using generalized linear models (GLM) and generalized linear mixed models (GLMM). For all models, the significance (α=0.05) of each predictor was assessed using a likelihood ratio test (LRT), and Tukey adjusted pairwise comparisons between means.

### Example 1

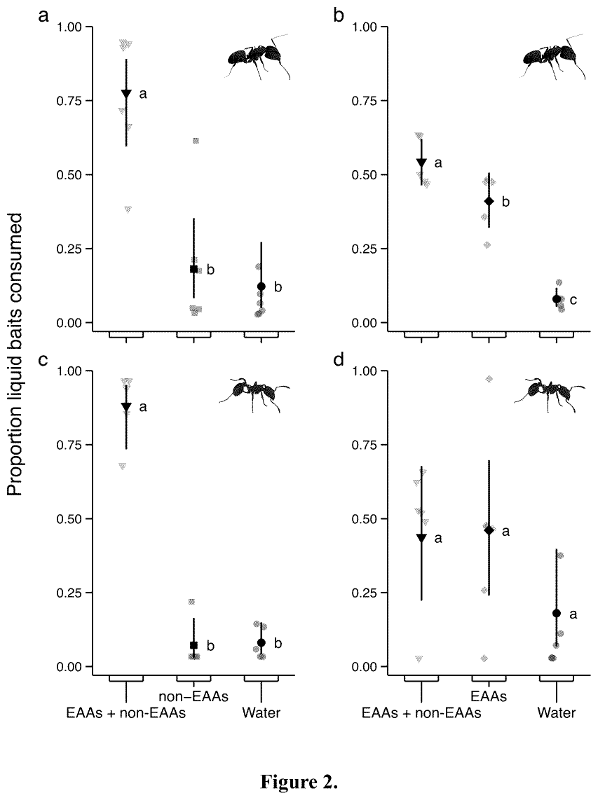

In Experiments 1-4, colonies of M. rubra and C. modoc preferentially consumed EAAs rather than non-EAAs, as shown in FIG. 2. Colonies of C. modoc (Exp. 1) and M. rubra (Exp. 2) were offered three choices: (1) 11 EAAs+10 non-EAAs (1.05% total w/v) in water; (2) 10 non-EAAs (0.5% w/v) in water; and (3) a water control. Additionally, colonies of C. modoc (Exp. 3) and M. rubra (Exp. 4) were offered: (1) 11 EAAs+10 non-EAAs (1.05% w/v) in water; (2) 11 EAAs (0.55% w/v) in water; and (3) a water control. The list of EAAs and non-EAAs is shown below in Table 1. Data were analyzed using generalized linear models (GLM) and generalized linear mixed models (GLMM). For all models, the significance (p 0.05) of each predictor was assessed using a likelihood ratio test (LRT), and Tukey adjusted pairwise comparisons between means.

TABLE 1
List of macro-nutrients [sucrose, EAAs, non-EAAs]

| Nutrients | Chemicals | Fraction of total^{a} | Supplier^{b} | % Purity | CAS |
|---|---|---|---|---|---|
| Sucrose | D-sucrose | 1.00 | SA | ≥99 | 57-50-1 |
| non-EAAs^{c} | L-asparagine | 0.1 | SA | ≥99 | 5794-13-8 |
| | L-aspartic acid | 0.1 | SA | ≥98 | 56-84-8 |
| | L-cysteine | 0.1 | SA | ≥97 | 52-90-4 |
| | L-glutamine | 0.1 | SA | ≥99 | 56-85-9 |
| | L-glycine | 0.1 | SA | ≥98 | 56-40-6 |
| | L-lysine | 0.1 | SA | ≥98.5 | 56-87-1 |
| | L-proline | 0.1 | SA | ≥99 | 147-85-3 |
| | L-serine | 0.1 | SA | ≥99 | 56-45-1 |
| | L-tyrosine | 0.1 | AC | ≥98 | 60-18-4 |
| | γ-amino butyric acid | 0.1 | SA | ≥99 | 56-12-2 |
| EAAs | L-glutamic acid | 0.091 | SA | 99 | 56-86-0 |
| | L-alanine | 0.091 | SA | ≥98 | 56-41-7 |
| | L-isoleucine | 0.091 | MI | ≥98 | 73-32-5 |
| | L-leucine | 0.091 | SA | 97 | 61-90-5 |
| | L-valine | 0.091 | SA | ≥98 | 72-18-4 |
| | L-tryptophan | 0.091 | SA | ≥98 | 73-22-3 |
| | L-arginine | 0.091 | SA | ≥98 | 74-79-3 |
| | L-histidine | 0.091 | SA | ≥99 | 71-00-1 |
| | L-threonine | 0.091 | SA | ≥98 | 72-19-5 |
| | L-methionine | 0.091 | SA | ≥98 | 63-68-3 |
| | L-phenylalanine | 0.091 | SA | 99 | 63-91-2 |

^{a}‘Fraction of total’ denotes the proportion of a chemical in a nutrient group.
^{b}SA = Sigma Aldrich, Burlington, MA, USA; AC = Anachemia Canada Inc., Lachine, Quebec, Canada; MI = Millipore, Burlington, MA, USA; OW = Oakwood Products, Inc., Estill, South Carolina, USA; FI = Fisher Scientific International, Inc., Pittsburgh, PA, USA; AA = Alfa Aesar, Ward Hill, MA, USA; CL Caledon Laboratories Ltd., Georgetown, ON, Canada; BS = Bio-Serv, Flemington, NJ, USA.
^{c}Amino acids listed as in Feldhaar & al. (2007).

In Experiments 1 and 2, the composition of amino acid blends (11 EAAs+10 non-EAAs or 10 non-EAAs only) significantly affected consumption by C. modoc (likelihood ratio test: χ²=21.59, d. f=2, p<0.0001) and M. rubra (LRT: χ²=28.279, d. f=2, p<0.0001). As shown in charts a (Exp. 1) and c (Exp. 2) of FIG. 2, ants consumed blends containing both EAAs and non-EAAs significantly more than blends containing only non-EAAs, which were ingested as little as the water control (Tukey adjusted p-value<0.05).

In Experiments 3 and 4, the composition of amino acid blends (11 EAAs+10 non-EAAs or 11 EAAs only) again significantly affected consumption by C. modoc (LRT: χ²=23.68, d. f=2, p<0.0001) but not by M. rubra (LRT: χ²=5.6, d. f=2, p=0.06), as shown in charts b and d of FIG. 2. As shown in chart b (Exp. 3) of FIG. 2, colonies of C. modoc consumed the blend of EAAs and non-EAAs only slightly more (but statistically significant) than the blend of EAAs, both blends being consumed more than water (Tukey adjusted p-value<0.05). In contrast, as shown in chart d (Exp. 4) of FIG. 2, colonies of M. rubra consumed the blend of EAAs and non-EAAs as much as the blend of EAAs, and they ingested both blends numerically (but not statistically) more than the water control (Tukey adjusted p-value>0.05).

In combination, the data demonstrate that M. rubra and C. modoc colonies with brood preferentially forage for EAAs rather than non-EAAs.

### Example 2

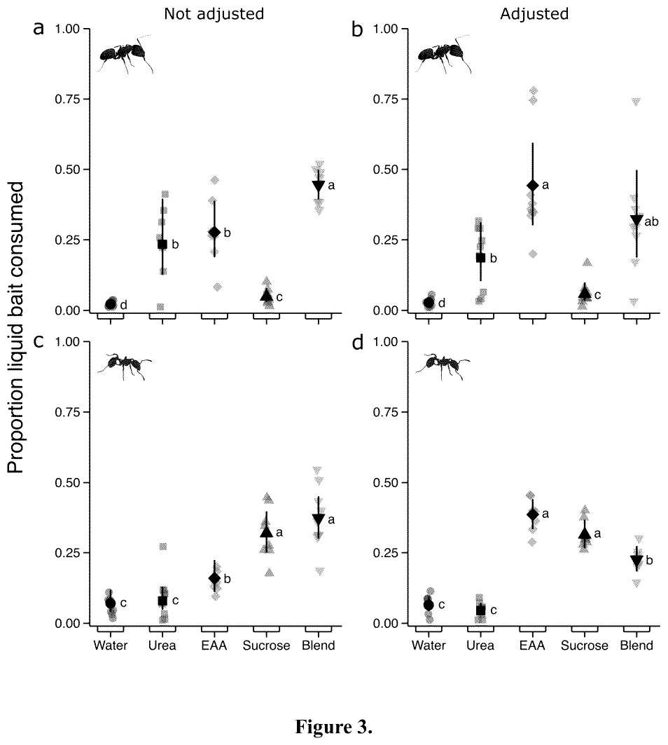

In Experiments 5-12, the blend of EAAs and sucrose proved to be an effective bait for C. modoc and M. rubra, as shown in FIG. 3. Experiments 5-8 tested consumption of macro-nutrients, i.e., urea, EAAs, and sucrose, by C. modoc and M. rubra colonies. Aqueous solutions of urea, EAAs, and sucrose were tested singly and in ternary combination, with plain water as the control stimulus. Each component in the ternary blend was tested at the lowest concentration found effective in pre-screening experiments. Single components were tested at the same “unadjusted’ concentration as in the ternary blend (urea 2.5% w/v, EAAs 0.55% w/v, sucrose 2.5% w/v) or at an “adjusted” concentration (5.55% w/v) that equaled the total concentration of the ternary blend (5.55% w/v).

As shown in charts a, b, c, and d of FIG. 3, colonies of C. modoc and M. rubra differentially consumed 1- and 3-component aqueous solutions of urea, EAAs, and sucrose, and plain water (control stimulus). Chart a (Exp. 5) of FIG. 3 shows the results for C. modoc: unadjusted concentrations of nutrients in aqueous solutions: LRT: χ²=71.15, d. f=4, p<0.0001. Chart b (Exp. 7) in FIG. 3 shows the results for C. modoc: adjusted concentrations: LRT: χ²=57.72, d. f=4, p<0.0001. Chart c (Exp. 6) in FIG. 3 shows the results for M. rubra: unadjusted concentrations: LRT: χ²=61.59, d. f=4, p<0.0001. Chart d (Exp. 8) in FIG. 3 shows the results for M. rubra: adjusted concentrations: LRT: χ²=91.7, d. f=4, p<0.0001.

As shown in charts a (Exp. 5) and b (Exp. 7) of FIG. 3, colonies of C. modoc preferentially consumed solutions containing urea, EAAs, or both (together with sucrose). At adjusted nutrient concentrations, EAAs on their own and in ternary combination with urea and sucrose were most heavily consumed. As shown in chart c (Exp. 6) of FIG. 3, when nutrient concentrations were unadjusted, M. rubra colonies preferentially consumed sucrose, and sucrose in ternary combination with urea and EAAs. As shown in chart d (Exp. 8) of FIG. 3, at adjusted nutrient concentrations, M. rubra colonies preferentially consumed single-nutrient solutions of EAAs and sucrose, followed by the ternary blend of EAAs, sucrose, and urea.

In Experiments 9-12, aqueous solutions of urea, EAAs, and sucrose were tested in all binary and ternary combinations, again with plain water as the control stimulus. Binary combinations were tested at the same “unadjusted” concentration as in the ternary blend (urea 2.5% w/v and EAA 0.55% w/v; urea 2.5% w/v and sucrose 2.5% w/v; EAA 0.55% w/v and sucrose 2.5% w/v) or at an “adjusted” concentration (urea 4.55% w/v and EAA 1.0% w/v; urea 2.775% w/v and sucrose 2.775% w/v; EAA 1.0% w/v and sucrose 4.55% w/v) that equaled the total concentration of the ternary blend (5.55% w/v).

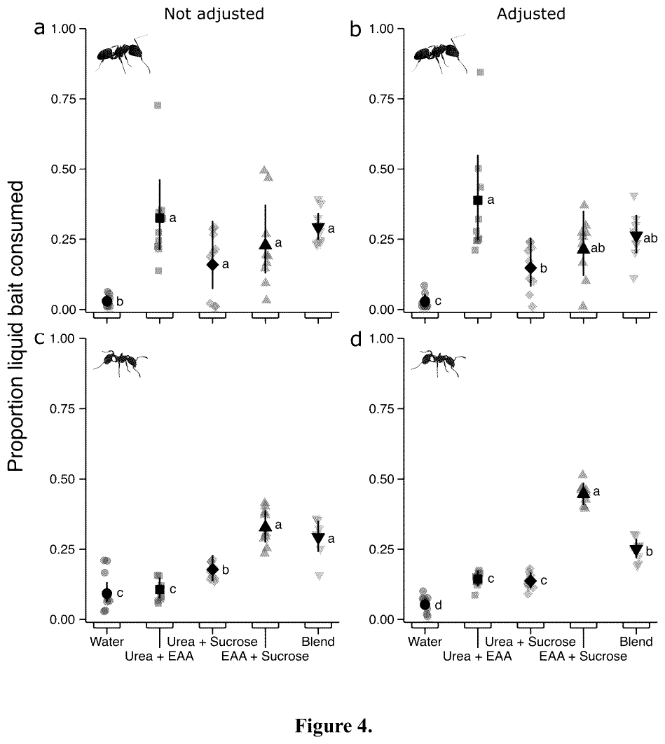

As shown in charts a, b, c, and d of FIG. 4, there was again differential consumption of macro-nutrients by C. modoc and M. rubra colonies when sucrose, EAAs, and urea were offered, at unadjusted and adjusted nutrient concentrations, in all possible binary and ternary combinations, along with plain water as the control stimulus. Chart a (Exp. 9) of FIG. 4 shows the results for C. modoc: unadjusted concentrations: LRT: χ²=30.79, d. f.=4, p<0.0001. Chart b (Exp. 11) of FIG. 4 shows the results for C. modoc: adjusted concentrations: LRT: χ²=30.71, d. f.=4, p<0.0001. Chart c (Exp. 10) of FIG. 4 shows the results for M. rubra: unadjusted concentrations: LRT: χ²=61.329, d. f.=4, p<0.0001. Chart d (Exp. 12) of FIG. 4 shows the results for M rubra: adjusted concentrations: LRT: χ²=115.38, d. f.=4, p<0.0001.

As shown in chart a (Exp. 9) of FIG. 4, at unadjusted nutrient concentrations, C. modoc colonies equally consumed all binary and ternary nutrient blends, significantly preferring all of them to plain water. As shown in chart b (Exp. 11) of FIG. 4, at adjusted nutrient concentrations, C. modoc colonies consumed the blend of urea and EAAs significantly more than the blend of urea and sucrose, and water, but not significantly more than the blend of EAAs and sucrose, and the ternary blend.

As shown in chart c (Exp. 10) of FIG. 4, at unadjusted nutrient concentrations, M. rubra colonies preferentially consumed the blend of EAAs and sucrose and the ternary blend, followed by the blend of urea and sucrose, and the blend of urea and EAAs, with the latter blend being consumed as little as water. As shown in chart d (Exp. 12) of FIG. 4, at adjusted nutrient concentrations, the blend of EAAs and sucrose was most heavily consumed, followed by the ternary blend, and then by the binary blend of urea and sucrose, and the binary blend of urea and EAAs, which had similar levels of consumption and were both significantly more consumed than water.

In combination, the data indicate that colonies of C. modoc preferentially and consistently consumed EAAs, and EAAs blended with sucrose, whereas M. rubra colonies generally consumed sucrose, and sucrose blended with EAAs.

### Example 3

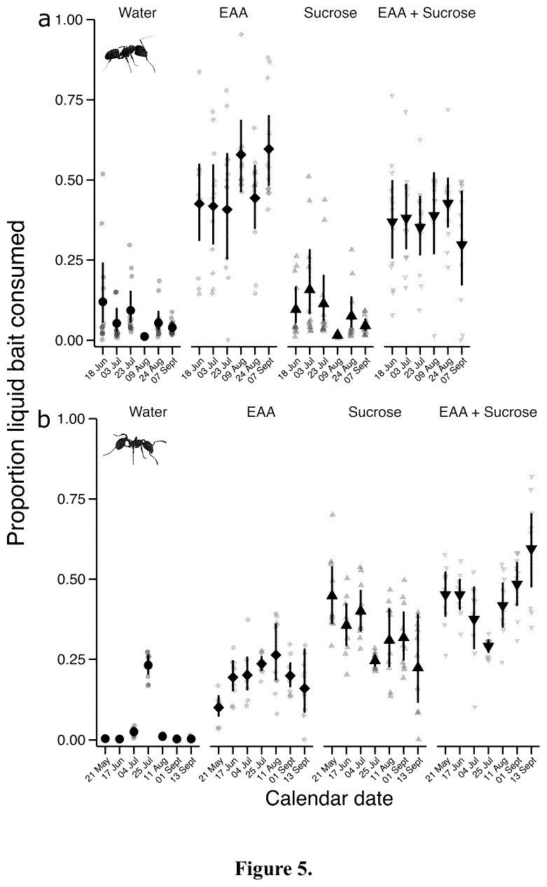

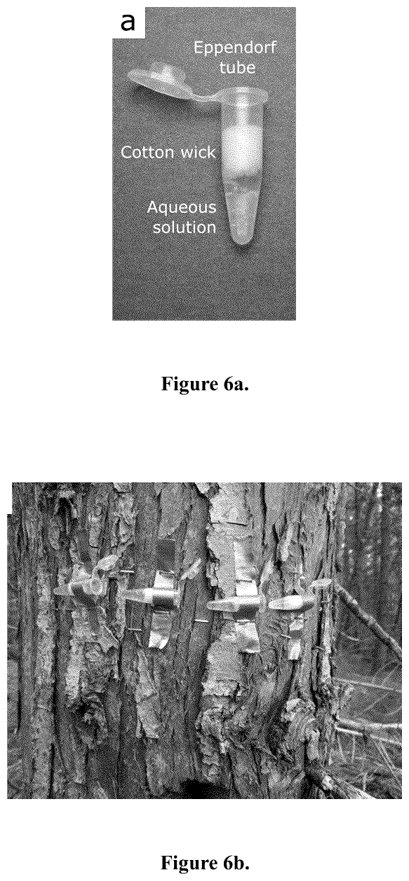

In Experiments 13 and 14, the bait of EAAs and sucrose proved to be effective throughout the entire field season, as shown in FIG. 5. In preparation for these experiments, Eppendorf tubes with nutrient solutions for ant consumption, as shown in FIG. 6a, and evaporation control tubes, were thawed and weighed as described above, and then transported to the field in a cooler. Tubes were spaced around the entrance of C. modoc and M. rubra nests, with tube positions randomly assigned in each replicate.

For the C. modoc experiment (Exp. 13), Eppendorf tubes were affixed 5 cm apart to trees or logs housing a colony as shown, for example, in FIG. 6b. For the M. rubra experiment (Exp. 14), tubes were placed 5 cm apart around the entrance of subterranean nests. Evaporation control tubes were placed in Tupperware containers (15 cm×9 cm×10 cm) with a mesh-covered hole in the lid, and containers were set near ant nests. Replicates with M. rubra colonies (n=10; repeated on 7 dates) were run for 4 hours, and replicates with C. modoc colonies (n=13; repeated on 6 dates) were run for 24 hours. After replicates were terminated, tubes were capped, transported to the laboratory in a cooler, and weighed. All field studies were run on warm and sunny days with observable ant activity.

Experiments 13 and 14 investigated potential seasonal shifts in nutrient preferences exhibited by field colonies of ants. Colonies of C. modoc were located along the Mamquam forest service road (near Squamish, BC, Canada) and colonies of M. rubra were located at Inter River Park (District of North Vancouver, BC, Canada). Drawing on results of Example 2 that both C. modoc and M. rubra had preferentially consumed the “adjusted” binary blend of EAA and sucrose, each ant colony was offered four Eppendorf tubes that contained: (1) EAA (5.55% w/v); (2) sucrose (5.55% w/v), (3) a blend of EAA (1.0% w/v) and sucrose (4.55% w/v); and (4) plain water (control). Throughout the summer season, nutrient consumption by colonies was measured in circa 3-week intervals on six dates for C. modoc colonies from Jun. 18, 2021 to Sep. 7, 2021, and on seven dates for M. rubra colonies from May 21, 2021 to Sep. 13, 2021.

In Experiment 13 with C. modoc colonies, bait nutrient(s), date, and interaction between bait nutrient(s) and date, were all significant predictors of bait consumption by ants, with the following results for the bait nutrient(s) LRT: χ²=371.1, d. f.=18, p<0.0001; date: LRT: χ²=117.04, d. f.=20, p<0.0001; and for interaction between bait nutrient(s) and date: LRT: χ²=109.95, d. f.=15, p<0.0001. Invariably over time, C. modoc colonies preferentially consumed EAAs, and EAAs and sucrose in a binary blend, as shown in chart a of FIG. 5. Also shown in chart a of FIG. 5, consumption of water, and of sugar, decreased over time.

Similarly, in Experiment 14 with M. rubra colonies, bait nutrient(s), date, and interaction between bait nutrient(s) and date, were all significant predictors of bait consumption by ants, with the following results for the bait nutrient(s): LRT: χ²=403.59, d. f=21, p<0.0001; date: LRT: χ²=267.51, d. f=24, p<0.0001; and for interaction between bait nutrient(s) and date: LRT: χ²=245.17, d. f.=18, p<0.0001. Across sampling dates, M. rubra colonies generally consumed more sucrose, and more sucrose and EAAs in a binary blend, than EAAs and water, as shown in chart b of FIG. 5. Also shown in chart b of FIG. 5, sucrose consumption declined over time, whereas the consumption of sucrose in a binary blend with EAAs increased during the last three sampling dates.

The data indicate that colonies of both C. modoc and M. rubra over an entire field season consistently consumed the blend of EAAs and sucrose, and that this blend will be effective for both sugar-loving ants (e.g., M. rubra) and protein/EAA-loving ants (e.g., C. modoc).

### Example 4

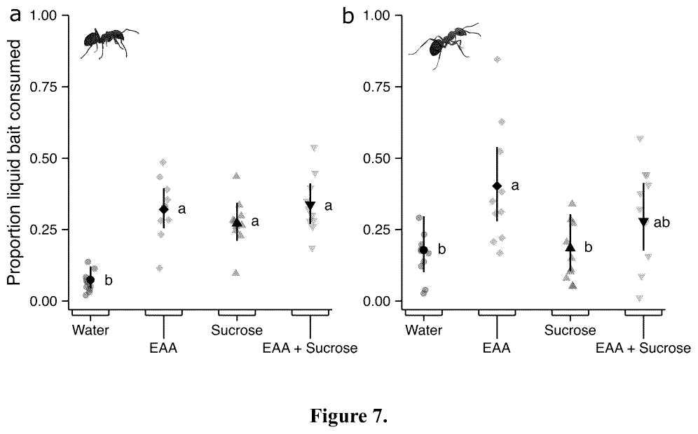

In Experiments 15 and 16, the bait of EAAs and sucrose was effective for diverse ant taxa including black garden ants and thatching ants, as shown in FIG. 7. In Experiment 15 (n=10), colonies of Lasius niger black garden ants were located at the base of trees on the Burnaby campus of Simon Fraser University, and tubes were affixed next to each other on tree trunks alongside the ants' foraging trails. In Experiment 16 (n=10), colonies of Formica aserva thatching ants were located along the Mamquam forest service road (see above), and tubes were placed on top of tree stumps that contained an ant colony. For both experiments, evaporation control tubes were placed in Tupperware containers (15 cm×9 cm×10 cm) with a mesh-covered hole in the lid, and containers were set near ant colonies. Each colony was offered four Eppendorf tubes that contained: (1) EAAs (5.55% w/v); (2) sucrose (5.55% w/v), (3) EAAs (1.0% w/v)+sucrose (4.55% w/v); and (4) plain water (control).

Bait nutrients affected bait consumption by L. niger colonies (LRT: χ²=48.33, d. f=3, p<0.0001; chart a of FIG. 7) and F. aserva colonies (LRT: χ²=12.29, d. f=3, p=0.006; chart b of FIG. 7. As shown in chart a (Exp. 15) of FIG. 7, colonies of L. niger equally consumed baits containing EAAs, sucrose, and the blend of EAAs and sucrose, all of which were preferred to plain water (control stimulus). As shown in chart b (Exp. 16) of FIG. 7, colonies of F. aserva preferentially consumed baits containing EAAs, which they consumed more than sucrose baits but (statistically) not more than the blend of EAAs and sucrose.

The data indicate that the bait of EAAs and sucrose is effective not only for C. modoc and M. rubra colonies but also for L. niger and F. aserva colonies.

### Example 5

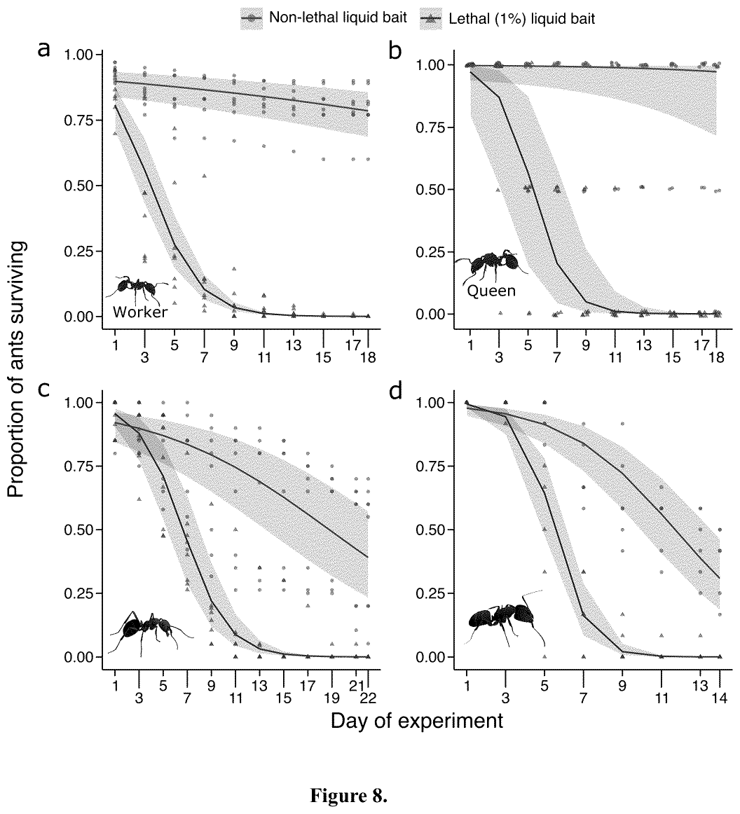

In Experiments 17-19, boric acid in ant baits proved to be not aversive to bait consumption by ants and lethal to diverse ant taxa, as shown in FIG. 8. To prepare liquid (aqueous) lethal baits, sucrose (4.55% w/v), 11 EAAs (1% w/v, as shown in Table 1), and boric acid (1% w/v) were dissolved under stirring in distilled water (50% of desired volume), after which more distilled water was added to reach the target weight by volume (w/v) solution. Liquid non-lethal baits were prepared similarly except that no boric acid was added. For efficiency, baits were prepared in large batches, and 1-mL and 8-mL bait aliquots were pipetted into 1.5-mL Eppendorf tubes and 15-mL Falcon tubes, respectively, which were then frozen until needed. Prior to deployment of bait tubes, they were thawed, and a 1-cm³ piece of cotton dental wick (Richmond Dental & Medical, Charlotte, NC 28205, USA) and a cotton ball were stuffed into Eppendorf and Falcon tubes, respectively, to retain the liquid bait while still enabling bait consumption by ants without spillage.

To assess bait appeal and lethality in various laboratory experiments, we tested entire M. rubra colonies, 20-worker groups of F. oreas, and 12-worker groups of C. modoc. For the F. oreas and C. modoc groups tested, workers were sorted from four and six laboratory colonies, respectively, and all worker sizes/castes were included. Colonies of M. rubra consisted of two queens and 100 workers sorted from field-collected ants. Colonies were housed in escape-proof Tupperware containers (17×17×6 cm or 24.4×12.7×8.9 cm) with a mesh-covered hole in the lid for air exchange.

Containers were fitted with a 10-mL test tube filled halfway with water and plugged with a cotton ball to provide a humid environment. All Tupperware containers were kept at 22° C. and a photoperiod of 12L:12D. Prior to the onset of any experiment, any dead workers were replaced with live ones. Every two days, ant colonies or groups of ants were provisioned with one or two bait-containing Eppendorf tubes, and deceased ants were counted.

To concurrently assess both bait lethality and potential bait aversion, treatment colonies of M. rubra (Exp. 17; n=8), and treatment groups F. oreas (Exp. 18; n=8) and C. modoc (Exp. 19; n=6), were offered a choice between a lethal and a non-lethal bait, each bait containing 4.55% (w/v) sucrose and 1% (w/v) EAAs, where only the lethal bait contained 1% (w/v) boric acid. Conversely, corresponding control colonies of M. rubra, and control groups C. modoc and F. oreas, were offered two non-lethal baits. Deceased ants were counted 24 hours after experiment initiation and then every 48 hours until all ants were deceased.

Testing M. rubra colonies (Exp. 17), at day 9 (midway through the experiment), proportionally (mean proportion; 95% confidence interval) fewer workers were still alive in treatment colonies feeding on the lethal bait (0.03; 0.02-0.06) than in control colonies feeding on the non-lethal bait (0.85; 0.78-0.91), as shown in chart a of FIG. 8. There was a significant effect of treatment (lethal vs. non-lethal bait: LRT: χ²=1739.2, d. f.=2, p<0.0001), day in experiment (LRT: χ²=3836.1, d. f.=2, p<0.0001), and interaction between treatment and day (LRT: χ²=1696.6, d. f.=1, p<0.0001) on worker ant survival.

Similarly, proportionally fewer M. rubra queens were still alive in treatment colonies (0.05; 0.01-0.26) than in control colonies (0.99; 0.89-1.0), as shown in chart b of FIG. 8. Again, there was a significant effect of treatment (LRT: χ²=2524.6, d. f.=2, p<0.0001), day in experiment (LRT: χ²=4621.5, d. f.=2, p<0.0001), and interaction between treatment and day (LRT: χ²=2481.9, d. f.=1, p<0.0001) on queen ant survival. In treatment colonies, all workers and queens were deceased on days 18 and 15, respectively.

Testing groups of F. oreas workers (Exp. 18), at day 11 proportionally fewer workers were still alive in treatment groups (0.09; 0.04-0.17) than in control groups (0.74; 0.58-0.86), as shown in chart c of FIG. 8. There was a significant effect of treatment (LRT: χ²=338.74, d. f.=2, p<0.0001), day in experiment (LRT: χ²=1592.7, d. f.=2, p<0.0001), and interaction between treatment and day (LRT: χ²=321.12, d. f.=1, p<0.0001). All workers in treatment groups were deceased by day 22.

Testing groups of C. modoc workers (Exp. 19), by day 7 proportionally fewer workers were still alive in treatment groups (0.16; 0.08-0.29) than in control groups (0.84; 0.73-0.91), as shown in chart d of FIG. 8. There was a significant effect of treatment (LRT: χ²=104.87, d. f.=2, p<0.0001), day in experiment (LRT: χ²=697.56, d. f.=2, p<0.0001), and interaction between treatment and day (LRT: χ²=79.379, d. f.=1, p<0.0001). All workers in treatment groups were deceased on day 14.

The data indicate that the presence of boric acid as a lethal agent in baits is not aversive to bait consumption and that boric acid at 1% (w/v) is lethal to diverse ant taxa.

### Example 6

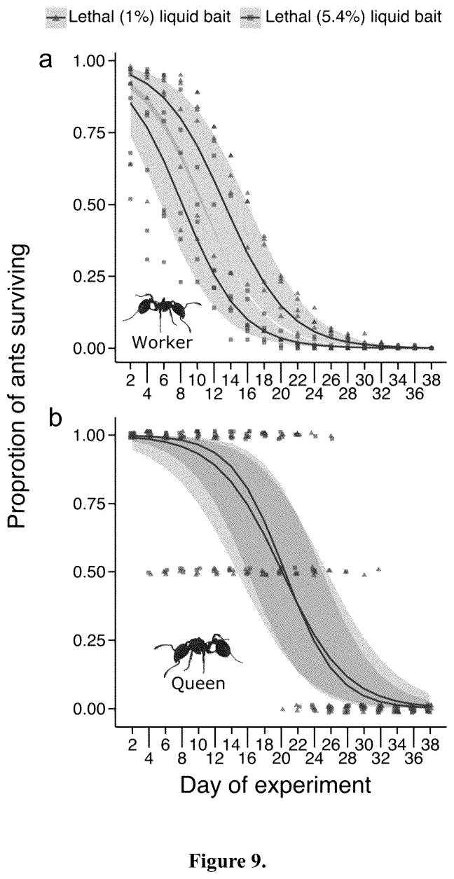

In Experiment 20, the use of boric acid in amounts of 1% and 5.4% in ant baits proved to be lethal to diverse ant taxa, as shown in FIG. 9. The effect of boric acid concentration (1% or 5.4% w/v, the latter concentration being commonly found in commercial baits) on the mortality of 12 M. rubra colonies was tested, where each colony contained 100 workers and two queens. Liquid baits were prepared with the same nutrient content (4.55% w/v sucrose, 1% w/v EAA) but a dissimilar boric acid concentration (1% or 5.4% w/v). As boric acid did not cause bait aversion by ants, as described above, there was no need to offer colonies a choice between lethal and non-lethal baits. Consequently, six colonies each were offered a single bait with 1% (w/v) boric acid or a single bait with 5.4% (w/v) boric acid. Every two days, bait tubes were replaced, and deceased worker and queen ants were counted, until all ants in all colonies were deceased.

At day 20 of the experiment, proportionally fewer worker ants were still alive in colonies feeding on the 5.4% (w/v) boric acid bait (0.03; 0.02-0.07) than in colonies feeding on the 1% (w/v) boric acid bait (0.15; 0.08-0.26), as shown in chart a of FIG. 9. There was a significant effect of treatment (1% or 5.4% boric acid; LRT: χ²=12.61, d. f.=2, p=0.002), day in experiment (LRT: χ²=12592, d. f.=2, p<0.0001), and interaction between treatment and day (LRT: χ²=6.9141, d. f.=1, p=0.009) on worker ant survival. Worker ants in all colonies were deceased by day 38. Conversely, as shown in chart b of FIG. 9, queen ant survival was not differentially affected by boric acid concentration (LRT: χ²=1.32, d. f.=2, p=0.52).

At day 20, proportionally as many queens survived ingestion of boric acid at 5.4% per bait (0.54; 0.23-0.82) and 1% per bait (0.51; 0.21-0.80), with the high and low boric acid concentration killing all queens by days 30 and 34, respectively. There was a significant effect of “day in experiment” on queen ant survival (LRT: χ²=320.84, d. f.=2, p<0.0001) but no significant effect of treatment and day interaction (LRT: χ²=1.31, d. f.=1, p=0.25).

The data show that increasing the concentration of boric acid, as the lethal agent in the bait, from 1% to 5.4% slightly accelerated the demise of M. rubra worker ants, but not queen ants, indicating that 1% boric acid as the lethal agent in baits is sufficient. This 1% (w/v) boric acid concentration is significantly lower than that commonly reported in commercial ant baits.

### Example 7

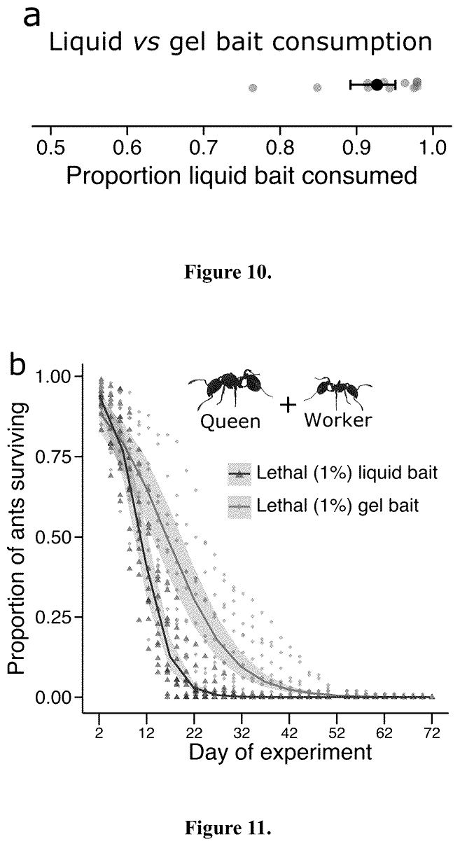

In Experiment 21, ants proved to consume more liquid bait than gel bait, as shown in FIG. 10. In Experiment 21, 12 laboratory colonies of M. rubra were offered a choice between a liquid bait and a gel bait, testing for preferential bait consumption. One day prior to the experiment, all colonies were food-deprived, and gel baits were prepared and kept refrigerated.

To prepare lethal gel baits, powdered gelatin (1.42%; Knox brand, TreeHouse Foods, Inc; Il, USA), sucrose (4.55% w/v), essential amino acids (1% w/v) and boric acid (1% w/v) were thoroughly mixed in a beaker, after which cold distilled water (10 mL) was added under stirring. When the mixture was semifluid, boiling water (10 mL) was added under stirring until all solutes were fully dissolved. Then, the mixture was transferred to a graduated cylinder, topped up with water for a total volume of 48 mL, poured back into the beaker and thoroughly mixed. Aliquots (1 mL) of this mixture were pipetted into 1.5-mL Eppendorf tubes which were refrigerated, and uncapped, for 1 hour to solidify the mixture. Unlike liquid baits, gel baits could not be frozen for preservation, and were prepared, and kept refrigerated, in batches sufficient to feed laboratory ant colonies for 2 weeks. Non-lethal gel baits were prepared following the same protocol except that no boric acid was added. Lethal liquid baits were prepared as described above.

On the day of the experiment, the frozen liquid baits in 1.5-mL Eppendorf tubes were thawed, stuffed with a cotton wick to retain the liquid, and both liquid and gel baits were weighed to the nearest 0.0001 g (TR 204 scale; Denver Instrument Company, CO, USA). For each replicate, liquid and gel bait Eppendorf tubes were taped to the edge of jar lids (diam: 15 cm), with their position on the lid randomly selected. To determine the weight loss of baits that was due to evaporation, rather than consumption by ants, one Eppendorf tube with liquid bait and one with gel bait were taped, inaccessible to ants, to the underside of bioassay container lids.

To initiate experimental replicates, all Eppendorf tubes were uncapped, and jar lids carrying the two bait tubes were placed on the soil surface inside containers. After ants had foraged for 6 hours, all tubes were capped and reweighed. Bait consumption was determined as the weight differential of Eppendorf tubes fed on by ants minus the weight differential of corresponding evaporation control tubes.

When M. rubra colonies were offered a choice between a non-lethal liquid bait and a non-lethal gel bait (Exp. 21), colonies consumed greater proportions of liquid baits (0.93; 0.89-0.95) than of gel baits (LRT: χ²=63.67, d. f.=1, p<0.0001), as shown in FIG. 10.

### Example 8

In Experiment 22, lethal liquid baits proved to cause faster demise of ant colonies than lethal gel baits, as shown in FIG. 11. Experiment 22 compared the lethality of liquid and gel baits to ants, both baits containing 1% boric acid as the lethal agent. Six colonies of M. rubra each received either a liquid or a gel bait. Every two days, baits were replaced and deceased ants were counted, until all ants in all colonies were deceased.

By day 36 (the midpoint of the experiment), proportionally fewer worker ants were still alive in colonies feeding on lethal liquid baits (0.005; 0.003-0.007) than in colonies feeding on lethal gel baits (0.05; 0.03-0.07). Liquid and gel baits killed all ants by day 39 and 73, respectively. There was a significant effect of treatment (liquid bait vs. gel bait; χ²=286.55, d. f.=2, p<0.0001), day in experiment (χ²=1625.3, d. f.=2, p<0.0001) and interaction between treatment and day (χ²=270.95, d. f.=1, p<0.0001), as shown in FIG. 11.

### Example 9

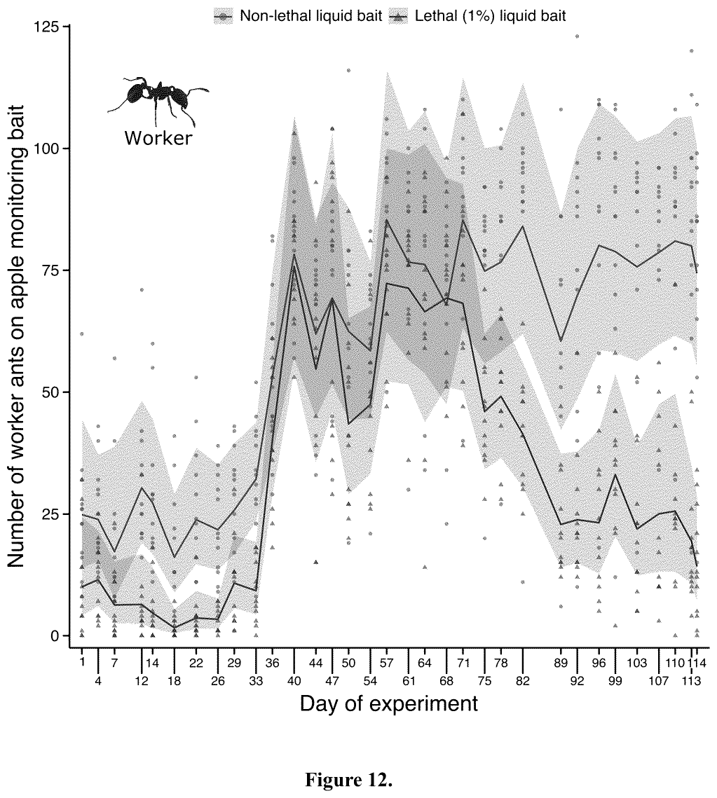

In Experiment 23, lethal liquid baits proved to reduce the size of M. rubra field colonies, as shown in FIG. 12. Experiment 23 tested the ability of the lethal liquid bait (4.55% w/v sucrose; 1% w/v EAA; 1% w/v boric acid) to reduce the size of M. rubra colonies in a field setting. Two ant-infested plots, which were separated by a 10-m natural land constriction, were selected at Inter River Park (North Vancouver, BC, Canada). In each plot, 12 colonies were flagged which were at least 2 m apart. Treatment- and control-plot colonies were baited with the lethal bait (4.55% w/v sucrose; 1% w/v EAA; 1% w/v boric acid) and the non-lethal liquid bait (4.55% w/v sucrose; 1% w/v EAA), respectively, which were replaced every day from Monday to Friday for 16 weeks. Twice per week (consistently between 08:30-11:30), colony demise was monitored by placing apple baits in petri dish lids (40 mm diam) next to colonies, photographing ants on apple baits 70 min later, and eventually counting ants on photographs using the cell counter tool in FIJI (V2.9.0/1.53t). Apple baits were prepared from 0.5-cm thick slices of ambrosia apples that were punched out into 19-mm discs with a cork cutter. Bait tubes and ant-monitoring apple baits were covered with a Unitrap lid (16.2 cm diameter; Forestry Distributing, Boulder, CO, USA) to provide weather protection and prevent bait tampering by animals.

During days 1-74 of the experiment, lethal and non-lethal liquid baits were presented in 1.5-mL Eppendorf tubes. When we noticed, around day 74, that both lethal and non-lethal bait reservoirs were empty at the time baits were replaced, 15-mL Falcon tubes (which held 8 mL of liquid bait) instead of 1.5-mL Eppendorf tubes were deployed to ensure sustained bait availability for ants.

As shown in FIG. 12, the lethal liquid bait reduced the size of M. rubra colonies in Inter River Park (Exp. 23) and thereby the overall M. rubra infestation. There was a significant effect of treatment (lethal bait vs. non-lethal bait) (χ²=487.92, d. f.=66, p<0.0001), day in experiment (χ²=1378.7, d. f.=128, p<0.0001), and interaction between treatment and day (χ²=414.09, d. f.=64, p<0.0001). Initially, fewer ants were counted on apple monitoring baits in the lethal treatment plot than in the non-lethal control plot, but the difference was not statistically significant (p>0.05). After 33 days, numbers of ants on apple baits spiked in both the treatment and the control plot and remained similarly high until day 71 (p>0.05). Following day 71, numbers of ants on apple baits sharply declined in the treatment plot but not the control plot (p<0.05).

The data indicate that the lethal liquid bait (4.55% w/v sucrose; 1% w/v EAA; 1% w/v boric acid) significantly reduced the size of M. rubra colonies at Inter River Park.

As used herein, all percentages (%) are expressed as weight by volume (w/v), the mass of solute divided by the volume of the solution multiplied by 100, or simply as %, unless otherwise indicated.

The dimensions and values disclosed herein are not to be understood as being strictly limited to the exact numerical values recited. Instead, unless otherwise specified, each such dimension is intended to mean both the recited value and a functionally equivalent range surrounding that value.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

Every document cited herein, including any cross-referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests, or discloses any such invention. Further, to the extent that any meaning or definition of a term in this document conflicts with any meaning or definition of the same term in a document incorporated by reference, the meaning or definition assigned to that term in the document shall govern.

The foregoing description of embodiments and examples has been presented for purposes of description. It is not intended to be exhaustive or limiting to the forms described. Numerous modifications are possible in light of the above teachings. Some of those modifications have been discussed and others will be understood by those skilled in the art. The embodiments were chosen and described for illustration of various embodiments. The scope is, of course, not limited to the examples or embodiments set forth herein, but can be employed in any number of applications and equivalent articles by those of ordinary skill in the art. Rather it is hereby intended the scope be defined by the claims appended hereto.

What is claimed is:

1. A composition for eliminating ants, the composition comprising:
one or more essential amino acids (EAAs), wherein the one or more EAAs are included in an amount of up to 5% (w/v);
one or more sugar compounds; and
a lethal agent.

2. The composition of claim 1, wherein the lethal agent is boric acid.

3. The composition of claim 2, comprising from about 1% to about 5.4% (w/v) boric acid.

4. The composition of claim 3, comprising from about 1% to about 2% (w/v) boric acid.

5. The composition of claim 1, wherein the sugar compound is one or more of sucrose, fructose, and glucose.

6. The composition of claim 1, comprising from about 1% to about 50% (w/v) of the one or more sugar compounds.

7. The composition of claim 1, comprising from about 4% to about 6% (w/v) of the one or more sugar compounds, wherein the sugar compound is sucrose.

8. The composition of claim 1, comprising from about 1% to about 5% (w/v) of the one or more EAAs.

9. The composition of claim 8, comprising from about 1% to about 2% (w/v) of the one or more EAAs.

10. The composition of claim 1, wherein the one or more EAAs include one or more of L-glutamic acid, L-alanine, L-isoleucine, L-leucine, L-valine, L-tryptophan, L-arginine, L-histidine, L-threonine, L-methionine, and L-phenylalanine.

11. The composition of claim 10, wherein the one or more EAAs include each of L-glutamic acid, L-alanine, L-isoleucine, L-leucine, L-valine, L-tryptophan, L-arginine, L-histidine, L-threonine, L-methionine, and L-phenylalanine.

12. The composition of claim 1, wherein each of the one or more EAAs is provided in the same amount.

13. The composition of claim 1, further comprising one or more non-essential amino acids (non-EAAs).

14. The composition of claim 13, wherein the one or more non-EAAs include one or more of L-asparagine, L-aspartic acid, L-cysteine, L-glutamine, L-glycine, L-lysine, L-proline, L-serine, L-tyrosine, and 7-amino butyric acid.

15. The composition of claim 14, wherein the one or more non-EAAs include each of L-asparagine, L-aspartic acid, L-cyteine, L-glutamine, L-glycine, L-lysine, L-proline, L-serine, L-tyrosine, and 7-amino butyric acid.

16. The composition of claim 14, wherein each of the one or more non-EAAs is provided in the same amount.

17. The composition of claim 1, wherein the composition is a liquid bait composition.

18. The composition of claim 1, wherein ants are of species from subfamilies selected from the group consisting of Agroecomyrmecinae; Amblyoponinae; Dolichoderinae; Dorylinae; Ectatomminae; Formicinae; Heteroponerinae; Leptanillinae; Martialinae; Myrmeciinae; Myrmicinae; Paraponerinae; Ponerinae; Proceratiinae; and Pseudomyrmecinae.

19. A liquid bait composition for controlling ants, the composition comprising:
from about 1% to about 5% (w/v) of one or more essential amino acids (EAAs), wherein the one or more EAAs include one or more of L-glutamic acid, L-alanine, L-isoleucine, L-leucine, L-valine, L-tryptophan, L-arginine, L-histidine, L-threonine, L-methionine, and L-phenylalanine;
from about 1% to about 50% (w/v) of one or more sugar compounds;
from about 1% to about 5.4% (w/v) of a lethal agent; and
water.

20. A method of using the liquid bait composition of claim 19, the method comprising
deploying the liquid bait composition to an ant bait station; and
positioning the ant bait station near an ant nest.
